(19) United States
(12) Patent Application Publication
(10) Pub. No.: US 2009/0239005 A1
(43) Pub. Date: Sep. 24, 2009

(54) EDGE IMPACT PROTECTOR

(76) Inventors: Mark P. Hawkins, Cooma (AU); Steven J. Acason, Cardiff (AU)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 12/299,001

(22) PCT Filed: Mar. 27, 2007
(86) PCT No.: PCT/AU07/00387

§ 371 Date: Mar. 6, 2009

(30) Foreign Application Priority Data
Mar. 27, 2006 (AU) 2006901556

(51) Int. Cl. B32B 1/06; B32B 3/06; B32B 1/04

(52) U.S. Cl. 428/34.1; 428/99

(57) ABSTRACT

An edge impact protector (10) comprising an elongate resiliently deformable body comprising first and second flange portions (16) and (18) extending from a shock absorbing corner portion (14), said first and second shock absorbing flange portions 16 and (18) carrying separate respective first and second relatively rigid elongate mounting plates (22) and (24), the first and second mounting plates (22) and (24) enabling the edge impact protector (10) to be mounted over an edge.

### FIELD OF THE INVENTION

The present invention relates to the field of safety edging, and in particular to edge impact protectors or bumpers configured to cover hard edges and corners so as to prevent injuries arising from impacting such edges.

### BACKGROUND OF THE INVENTION

Many Injuries arise from impact against hard corners or edges in various environments. Installations such as stairs, kerbs and various types of railings all have hard edges which constitute a potential safety hazard, in that they present an impact zone which is potentially penetrative and unyielding.

An average of 19 children are apparently admitted to hospital per day in NSW with a playground related injury, with the highest rate of injury occurring in children between the ages of one and five. Most playground injuries relate from a fall from playground equipment. A significant proportion of arm and head related injuries arise from collision of a child's arm or head with a hard edge.

The inclusion of cushioning materials which attenuate the impacts associated with a fall from heights have reduced injuries. However there is still a significant injury risk associated with many playgrounds in both Australia and the rest of the world.

It is known in related art to use releasably attachable bumpers that may be attached to the edges of tables, chairs and the like. U.S. Pat. No. 5,639,072 to McCall teaches a bumper that is a cushion which is essentially cylindrical, with a section cut out along the longitudinal axis to form a slot along the length of the bumper. The bumper is attached to the edge of the furniture using a plurality of releasable Velcro-type fasteners.

Other Systems using releasable attachment means for the bumper cushion to furniture are best suited to indoor applications in relatively controlled environments. For example, U.S. Pat. No. 5,527,097 to Martin teaches an edge member for a chair which has a chamber with a pair of flanges connected by a beam perpendicular to the flanges, the edge member secured to the chair using staples to attach the flanges to either side of the chair frame.

U.S. Pat. No. 5,283,096 to Greenberg teaches a flexible protective strip that locks into a metal or plastic longitudinally extending channel section which is affixed to a surface between edges. However, it is relatively complex in construction and significantly increases the profile of the protected edge.

Accordingly the present inventor has identified shortcomings in the systems and methods of the prior art and has sought ameliorate at least some of the deficiencies and problems associated with these systems and methods. These and other advantages of the present invention will become apparent from reading the following description.

Any discussion of documents, publications, acts, devices, substances, articles, materials or the like which is included in the present specification has been done so for the sole purpose so as to provide a contextual basis for the present invention. Any such discussions are not to be understood as admission of subject matter which forms the prior art base, or any part of the common general knowledge of the relevant technical field in relation to the technical field of the present invention to which it extended at the priority date or dates of the present invention.

### SUMMARY OF THE INVENTION

In one aspect the present invention provides an edge impact protector comprising an elongate resiliently deformable body comprising first and second shock absorbing flange portions extending from a shock absorbing corner portion, said first and second flange portions carrying separate respective first and second relatively rigid elongate mounting plates, the first and second mounting plates enabling the edge impact protector to be mounted over an edge.

Advantageously, the first and second mounting plates define first and second relatively rigid mounting zones and the shock absorbing corner portion defines an intermediate flexible zone for allowing an included angle defined between the first and second flange portions to be varied depending on the angle between adjacent surfaces between which the edge is defined. The included angle of the edge impact protector may be varied by plus or minus 30 degrees.

The first and second mounting plates may each be formed with at least one mounting aperture for receiving mechanical fasteners for mounting the impact protector over the edge. The flange portions may also be formed with apertures which align with corresponding apertures formed in the mounting plates, the portions being of a depth sufficient to allow heads of said mechanical fasteners to be recessed.

Preferably the edge impact protector has a profile arranged to vary in substantial conformity with the profile of an edge being covered.

For example, the edge impact protector may have a profile which is substantially L-shaped, substantially U-shaped, or substantially V-shaped.

The first and second inner faces of the first and second flange portions may be formed with recesses for receiving the respective first and second mounting plates, with the mounting plates being bonded in position within the recesses.

Alternatively, the first and second mounting plates may be encapsulated at a depth of between 1 mm and 3 mm within the first and second flange portions respectively.

Advantageously, the shock absorbing corner portion has an elongate cavity defined therein, the cavity bounded by an outer arcuate web and an inner corner defining web which are arranged to facilitate flexibility of the intermediate flexible zone.

Each end of the cavity may be sealed to provide a closed air cell providing a pneumatic cushion. The cavity may be filled with a cushioning material such as a closed cell foam material.

The shock absorbing portion of the edge impact protector may comprise a protruding bumper which extends beyond the planes of the outer surfaces of the first and second flange portions.

### BRIEF DESCRIPTION OF THE DRAWINGS

FIG. 1 shows a top perspective of the first embodiment of an edge impact protector;

FIG. 2 shows an end-on view of the edge impact protector of FIG. 1;

FIG. 3 shows a cross-sectional view of the edge impact protector of FIGS. 1 and 2 mounted in position on a hard edge;

FIG. 4 shows a top perspective view of a second embodiment of an edge impact protector of the invention;

FIG. 5 shows an end-on view of the edge impact protector of FIG. 4; and

FIG. 6 shows an end on view of an impact protector according to a second embodiment.

### DETAILED DESCRIPTION OF THE EMBODIMENTS

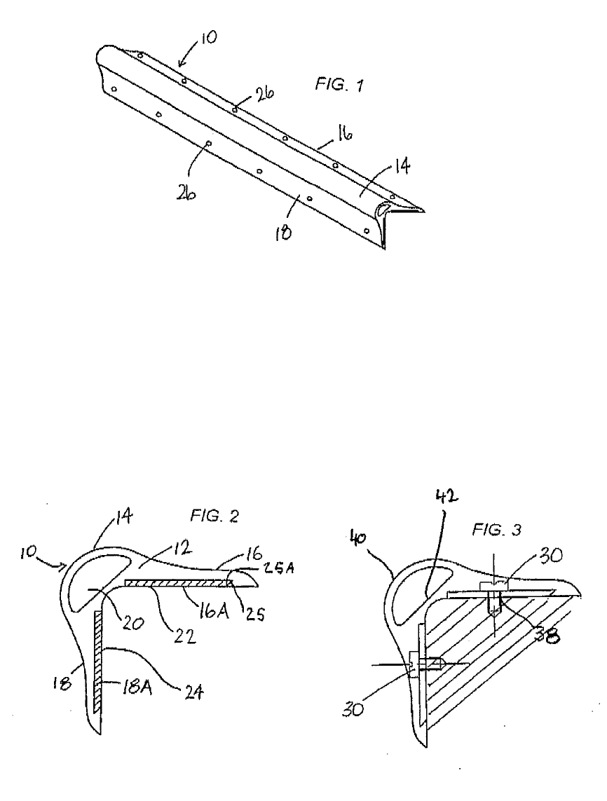

Referring first to FIGS. 1 and 2, a first embodiment of an edge impact protector or bumper 10 of the invention comprises a resiliently deformable body 12 formed from VIBRATHANE® 6012 manufactured by Crompton Uniroyal Chemical. This is a mid-terminated polyester based prepolymer which is extended with a curative such as Moca® by Eracure to yield a urethane having hardness varying from 87A to 53D, typically around 60D. Alternatively, various resilient synthetic or natural rubber materials may be used, which have the desired cushioning effect.

The deformable body 12 has a shock absorbing corner portion 14 from which first and second shock absorbing flange portions 16 and 18 extend. The corner portion is formed with a cavity 20 having a part circular profile and defining an outer arcuate web 40 and an inner corner defining web 42, in an alternative form of the invention, the cavity may be filled with polyurethane foam.

Recesses 16A and 18A are defined in the inner surfaces of the respective flange portions 16 and 18, and receive elongated steel plates 22 and 24 in a snug fit.

During production, the steel plates are typically held in position with magnets within the mould cavity. The inner surfaces of the steel plates may be sand blasted to facilitate adhesion with the polyurethane body. The steel plates 22 and 24 are then integrally moulded with the polyurethane body. The plates may be formed other metals or metal alloys such as aluminium.

When carried by the flanges 16 and 18 the steel plates 22 and 24 form relatively rigid mounting zones in those flanges. The intermediate corner portion provides a flexible zone between these rigid mounting zones. As discussed below, the deformability of the VIBRATHANE® and the independence of the mounting zones allow the flanges to be moved relative to one another to very the included angle of the protector. This in turn allows the protector to be fitted to edges having adjacent surfaces which are of an angle of greater or less than 90 degrees or which are irregular along their length.

In an alternative form of the invention, as shown in FIG. 6, the edge impact protector is produced with steel plates 22 and 24 encapsulated entirely within the flange portions 16 and 18 of the body. This form of the invention may be produced by offsetting the steel plates 22 and 24 from the mould surface prior to introducing the polyurethane. The polyurethane then fills the gaps between the steel plates 22 and 24 and the mould edge and sets such that the steel plates 22 and 24 are encapsulated within the body at a depth of 2 mm from the edges of the flanges which mount on the edge.

In a further alternative form of the invention, the body may be extruded and the plates subsequently bonded in position using a suitable adhesive. In the particular embodiment, the stainless plates are 20 mm wide and 1.2 mm thick. In the manufacturing process, lengths of typically 1 m or more are provided, which are then cut to size. Typically, in a playground environment the edge strip assemblies are cut to lengths of around 900 mm. The mounting plate may be co-extensive with the flanges, or may be provided at shortly spaced intervals. By providing gaps between successive plates, the flanges may be more easily cut to a desired length. In addition, the gaps provide a zone of flexure for enabling protectors to be fitted to edges which are not rectilinear.

Each plate has a chamfered edge 25 which contacts a complemental angled face 25A of the body to assist in holding the distal ends of the body in place against an edge face.

As can be seen from FIGS. 1 and 3, both the flanges 16 and 18 and the stainless steel plates 22 and 24 have respective apertures 26 and 28 formed at regular intervals for receiving mechanical fasteners such as screws 30, rails or rivets. The flanges 16 and 18 are formed with recesses in the polyurethane aligning with the apertures 26 and 28 in the plates 22 and 24. The depth of the recesses is greater than the height of the screw head so that the head is not exposed to provide an injury hazard. In FIG. 3, the edge impact protector is shown mounted firmly in position over the corner of a wooden sleeper 32 having top and side faces 34 and 36 respectively.

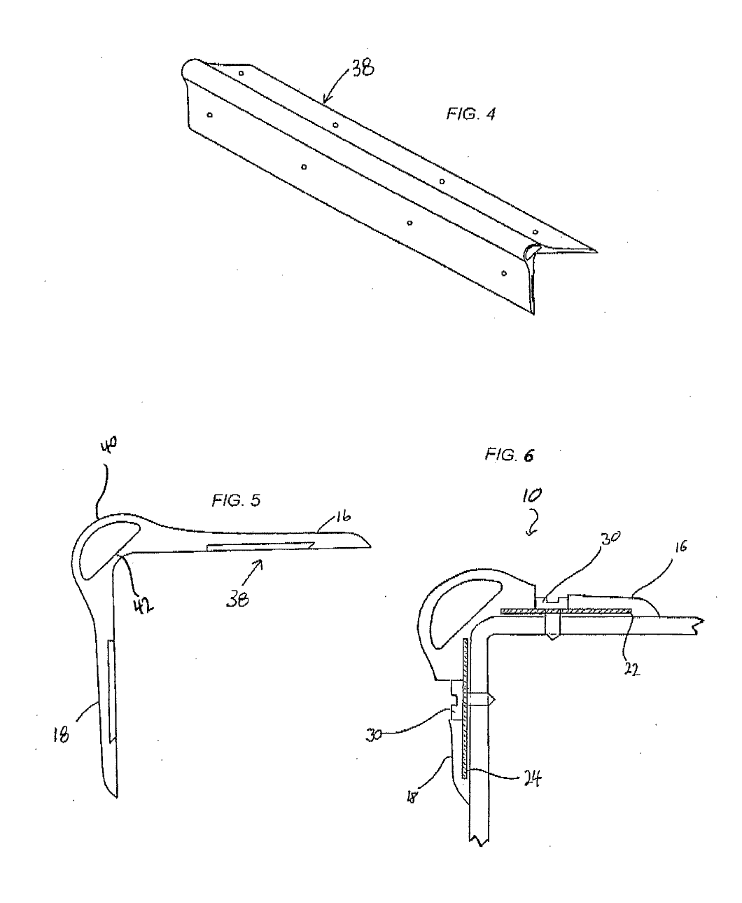

Referring now to FIGS. 4 and 5, a second embodiment of an edge impact protector 38 is shown which is arranged to be fitted over concrete steps. The edge impact protector is similar to that of FIGS. 1 to 3, save that it is formed with longer flanges 16 and 18. If desired the length of the Mounting plates 22 and 24 may be extended to account for the longer flanges 16 and 18. Alternatively, additional mounting plates may be provided along the length of each flange 16 and 18 to provide for more flexibility in each of the flanges 16 and 18. It will be appreciated that in certain embodiments the relative lengths of the flanges 16 and 18 may vary.

In both of the embodiments described, the edge impact protector has an included angle of 90°. It will be appreciated that numerous other included angles may be provided, depending upon the configuration of the edge being protected. Further, an advantage of the edge impact protector is that as the assembly is provided with independent mounting plates 22 and 24 the protector 10 is deformable at the corner portion. The deformability of the protector 10 will depend on the elasticity of the material being used, as well as on the particular profile. The cavity 20 facilitates deformation as the outer arcuate web 40 and inner corner defining web 42 of the corner portion are able to deform more readily.

Variation of plus or minus 30 degrees from the original included angle may be achieved with a protector of the type illustrated in FIGS. 1 to 6. For example, in the case of an L-shaped protector (having an original included angle of 90°), the protector may be configured to fit snugly over edges having a varying range of included angles between 10 degrees and 120 degrees. At the same time, the relatively rigid mounting plates allow the edge strip assemblies to be mounted firmly in position in harsh outdoor environments where they need to be mounted sufficiently firmly to withstand heavy pedestrian traffic, vandals and varying weather conditions. Alternatively, the protectors may be mounted in heavy traffic environments, for example on the steps of buses.

In an alternative form of the invention, the edge impact protector may be bonded to the surfaces of an edge using a suitable adhesive. The edge is prepared by applying a suitable sealer such as Bostik® N49 sealer to the surfaces of the edge to be covered. Thereafter, an adhesive such as Bostik Sikaflex® is applied to the edge and inner surfaces of the sealed plates before bonding the edge impact protector in position.

The particular profile of the edge impact protector not only provides an impact absorbing function, but also a grippable non-slip surface. In addition, depending on the colour of the edge strip protector, it may act as a visual aid. It can also act as a tactile edge indicator allowing for unsighted notification of an edge.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. An edge impact protector comprising an elongate resiliently deformable body comprising first and second shock absorbing flange portions extending from a shock absorbing corner portion, said first and second flange portions carrying separate respective first and second relatively rigid elongate mounting plates, the first and second mounting plates enabling the edge impact protector to be mounted over an edge.

2. An edge impact protector as claimed in claim 1, wherein the first and second mounting plates define first and second relatively rigid mounting zones and the shock absorbing corner portion defines an intermediate flexible zone for allowing an included angle defined between the first and second flange portions to be varied depending on the angle between adjacent surfaces between which the edge is defined.

3. An edge impact protector as claimed in claim 2, wherein the included angle can be varied by plus or minus 30 degrees.

4. An edge impact protector as claimed in claim 1, wherein the first and second mounting plates are each formed with at least one mounting aperture for receiving mechanical fasteners for mounting the impact protector over the edge.

5. An edge impact protector as claimed in claim 4, wherein the flange portions are formed with apertures which align with corresponding apertures formed in the mounting plates, the portions being of a depth sufficient to allow heads of said mechanical fasteners to be recessed.

6. An edge impact protector as claimed in claim 1, wherein the edge impact protector has a profile arranged to vary in substantial conformity with the profile of an edge being covered.

7. An edge impact protector as claimed in claim 1, wherein the edge impact protector has a profile which is substantially L-shaped.

8. An edge impact protector as claimed in claim 1, wherein the edge impact protector has a profile which is substantially U-shaped.

9. An edge impact protector as claimed in claim 1, wherein the edge impact protector has a profile which is substantially V-shaped.

10. An edge impact protector as claimed in claim 1, wherein first and second inner faces of the first and second flange portions are formed with recesses for receiving the respective first and second mounting plates, with the mounting plates being bonded in position within the recesses.

11. An edge impact protector as claimed in claim 1, wherein the first and second mounting plates are encapsulated at a depth of between 1 mm and 3 mm within the first and second flange portions respectively.

12. An edge impact protector as claimed in claim 1, wherein the shock absorbing corner portion has an elongate cavity defined therein.

13. An edge impact protector as claimed in claim 12, wherein the cavity is bounded by an outer arcuate web and an inner corner defining web.

14. An edge impact protector as claimed in claim 13, wherein the outer arcuate web and the inner corner web are arranged to facilitate flexibility of the intermediate flexible zone.

15. An edge impact protector as claimed in claim 12, wherein each end of the cavity is sealed to provide a closed air cell providing a pneumatic cushion,

16. An edge impact protector as claimed in claim 12, wherein the cavity is filled with a cushioning material.

17. An edge impact protector as claimed in claim 16, wherein the cushioning material is a closed cell foam material.

18. An edge impact protector as claimed in claim 1, wherein the shock absorbing portion comprises a protruding bumper which extends beyond the planes of the outer surfaces of the first and second flange portions.

19. (canceled)
